(19) United States
(12) Patent Application Publication
(10) Pub. No.: US 2010/0160120 A1
(43) Pub. Date: Jun. 24, 2010

(54) PROGRAMMABLE UNIVERSAL EXERCISE DEVICE

(75) Inventor: Yoram Duchovne, Shaarey Tikva (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: LPT TECHNOLOGIES LTD., Rosh Haayin (IL)

(21) Appl. No.: 12/296,137

(22) PCT Filed: Apr. 26, 2007
(86) PCT No.: PCT/IL07/00516

§ 371 Date: Oct. 6, 2008

(30) Foreign Application Priority Data
Apr. 26, 2006 (IL) 175234

(51) Int. Cl. A63B 22/04

(52) U.S. Cl. 482/53; 482/52

(57) ABSTRACT

An exercise device provides first and second foot-support surfaces which are each displaced by an actuator system along an arbitrary path defined in at least two dimensions over a range of at least 25 centimeters by 15 centimeters. A control system is configured to control the actuator system so as to generate an exercise path for each of the first and second foot-support surfaces. The exercise movement may be active or passive, and may be varied dynamically during an uninterrupted exercise session.

### FIELD AND BACKGROUND OF THE INVENTION

The present invention relates to exercise devices and, in particular, it concerns an exercise device which allows real-time variation of a path of motion during the course of an exercise session.

Various types of exercise devices are known. Referring particularly to exercise devices in which a person employs two legs, the devices are generally classified by the shape of the path of motion: circular paths of motion are “bicycle” type devices; up-down paths define “stepping” type devices; front-back motions define “skiing” type device etc.

Various devices have been proposed which can be modified by a user to provide more than one type of motion. These devices typically require a mechanical adjustment of the device while not in use, and cannot change the type of motion during the course of an exercise session without interrupting the session.

There is therefore a need for an exercise device which would provide real-time variation of a path of motion during an uninterrupted exercise session, and/or which would provide additional modes of operation beyond what is provided by conventional exercise devices.

### SUMMARY OF THE INVENTION

The present invention is an exercise device which allows real-time variation of a path of motion during the course of an exercise session.

According to the teachings of the present invention there is provided, an exercise device comprising: (a) a first foot-support surface; (b) a second foot-support surface; (c) an actuator system associated with the first and second foot-support surfaces and configured to displace each of the first and second foot-support surfaces along an arbitrary path defined in at least two dimensions over a range of at least 25 centimeters by 15 centimeters; and (d) a control system associated with the actuator system and configured for controlling the actuator system so as to generate an exercise path for each of the first and second foot-support surfaces.

According to a further feature of the present invention, the actuator system is configured to displace each of the first and second foot-support surfaces along an arbitrary path defined in at least two dimensions over a range of at least 70 centimeters by 40 centimeters.

According to a further feature of the present invention, the actuator system is further configured to control a rotational state of the first and second foot-support surfaces about at least one axis.

According to a further feature of the present invention, the control system is configured to actively displace the first and second foot-support surfaces along the arbitrary path so as to move the legs of a user.

According to a further feature of the present invention, the control system is configured to delimit permitted motion of the first and second foot-support surfaces to the arbitrary path such that the first and second foot-support surfaces are moved along the arbitrary path by motion of the legs of a user.

According to a further feature of the present invention, the actuator system is further configured to generate resistive forces under control of the control system so as to provide a given profile of resistance to motion along the arbitrary path.

According to a further feature of the present invention, the actuator system is configured to displace each of the first and second foot-support surfaces along an arbitrary path defined in three dimensions.

According to a further feature of the present invention, the control system is configured to change the arbitrary path during the course of an uninterrupted exercise session.

According to a further feature of the present invention, the control system is associated with an audio-visual entertainment system, and is configured to vary the arbitrary path synchronously with events presented by the audio-visual entertainment system.

According to a further feature of the present invention, the control system is configured to switch between at least two arbitrary paths chosen to simulate motions selected from the group consisting of: a cycling motion; a stepping motion; a walking motion; a running motion; and a skiing motion.

According to a further feature of the present invention, the arbitrary path is modified by motion simulation effects generated synchronously with events presented by the audio-visual entertainment system.

According to a further feature of the present invention, the control system is configured to switch between at least two arbitrary paths chosen to simulate motions selected from the group consisting of: a cycling motion; a stepping motion; a walking motion; a running motion; and a skiing motion.

According to a further feature of the present invention, the control system is configured to operate the actuator system in at least one mode wherein the first and second foot-support surfaces are displaced in equal but opposite motions.

According to a further feature of the present invention, the control system is configured to operate the actuator system in at least one mode wherein the first and second foot-support surfaces are displaced synchronously in parallel motions.

According to a further feature of the present invention, the control system is configured to operate the actuator system in at least one mode wherein the first and second foot-support surfaces are displaced non-synchronously.

According to a further feature of the present invention, the actuator system includes a plurality of linear actuators.

According to a further feature of the present invention, the actuator system includes a plurality of electrically controlled actuators.

According to a further feature of the present invention, the actuator system includes a plurality of hydraulic actuators.

According to a further feature of the present invention, the first and second foot-support surfaces are each implemented as parts of a conveyor belt, and wherein the actuator system includes a drive mechanism for driving each of the conveyor belts.

### BRIEF DESCRIPTION OF THE DRAWINGS

The invention is herein described, by way of example only, with reference to the accompanying drawings, wherein:

FIGS. 1-4 are schematic illustrations of a first implementation of the exercise device of the present invention illustrating a number of different paths of motion.

FIG. 5 is a schematic illustration of a second implementation of the exercise device of the present invention;

FIG. 6 is a schematic illustration of a third implementation of the exercise device of the present invention;

FIGS. 7-9 illustrate schematically three further options of actuator systems useful for implementing the present invention; and

FIGS. 10-10B illustrate schematically a yet further option of an actuator system, based upon vertically displaceable conveyor belts for each foot, useful for implementing the present invention.

### DESCRIPTION OF THE PREFERRED EMBODIMENTS

The present invention is an exercise device.

The principles and operation of exercise devices according to the present invention may be better understood with reference to the drawings and the accompanying description.

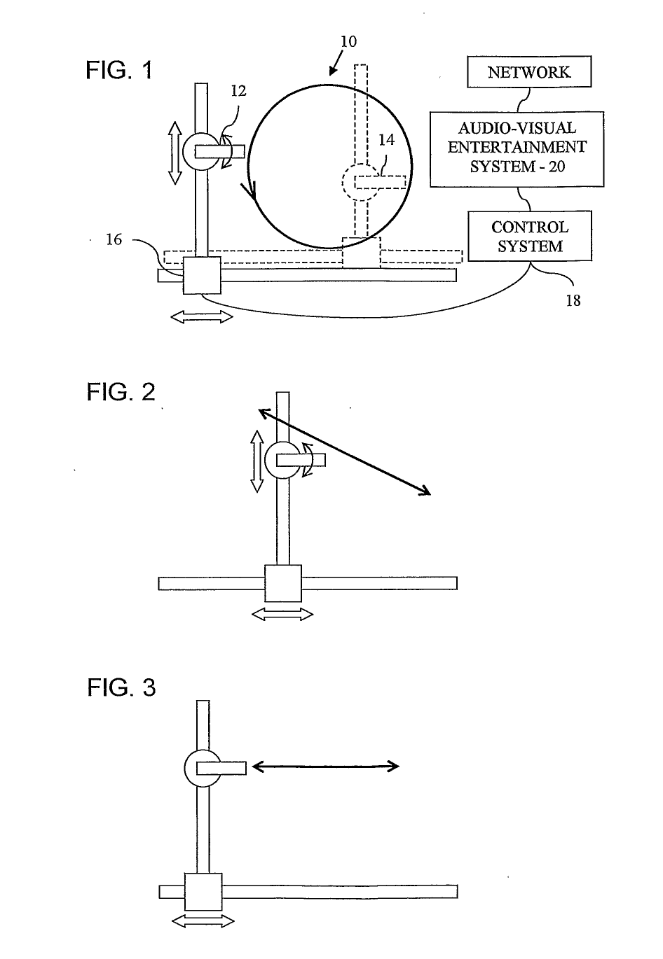

Referring now to the drawings, FIGS. 1-4 show a first implementation of an exercise device, generally designated 10, constructed and operative according to the teachings of the present invention. Generally speaking, exercise device 10 includes a first foot-support surface 12, a second foot-support surface 14, and an actuator system 16 configured to displace each of the first and second foot-support surfaces along an arbitrary path defined in at least two dimensions over a range of at least 25 centimeters by 15 centimeters. Actuator system 16 is controlled by a control system 18 so as to generate an exercise path for each of foot-support surfaces 12 and 14.

For simplicity of presentation, only one foot-support surface 12 and only one half of actuator system 16 will be shown in the subsequent figures. Similarly, control system 18 and its optional associated components (to be described below) will be omitted from the subsequent figures. It will be understood that at least the primary components recited thus far are implicitly included in each implementation.

The device of the present invention preferably provides a number of modes of exercise, which may include standard exercise patterns corresponding to conventional exercise devices, additional exercise patterns specific to the device of the present invention, and/or exercise patterns programmed individually by a user or generated interactively with an entertainments system or the like, as will be described below. The range of displacement of the foot-support surfaces required for generating each type of motion depends on the geometric parameters of the motion required. For example, elliptical trainers typically require about 40 cm by about 15 cm; cycling typically requires about 35 cm by 35 cm; and stepping typically requires about 28 cm by 17 cm. In order to provide all of these patterns and more, and to allow modification of parameters for a wide range of sizes of users, actuator system 16 is most preferably configured to displace each of the first and second foot-support surfaces along an arbitrary path defined in at least two dimensions over a range of at least 70 centimeters by 40 centimeters. Within this range of motion, the actuator system is preferably configured such that it is capable of following substantially any continuous path defined by control system 18. In certain preferred implementations, actuator system 16 provides an additional degree of freedom of linear displacement, thus allowing it to follow a path of motion defined in three dimensions. Additionally, or alternatively, actuator system 16 may be further configured to control a rotational state of the foot-support surfaces about at least one axis, and optionally about two or three rotational axes.

The exercise device of the present invention may be configured to operate in either a passive mode, i.e., where the motion is primarily in the same direction as the force applied by the user (the user is active and the device is passive/reactive), or in an active mode, i.e., where the device moves limbs of the user and the user exerts resistive force, primarily in a direction opposite to the direction of motion (the device is active and the user is passive/reactive). In certain implementations, the device may switch between active and passive modes. In other cases, a single path of motion may have both active and passive parts, such as the upward return motion of a cycling action where the weight of the leg tends to oppose the motion.

In the case of active modes of operation, control system 18 is configured to actively displace the foot-support surfaces along the arbitrary path so as to displace the legs of a user.

In the case of passive modes of operation, control system 18 is configured to delimit permitted motion of the foot-support surfaces to the arbitrary path such that the first and second foot-support surfaces are moved along the arbitrary path by motion of the legs of a user. Preferably, actuator system 16 is further configured to generate resistive forces under control of the control system 18 so as to provide a given profile of resistance to motion along the arbitrary path.

Many options for implementing passive systems may be implemented. According to one non-limiting example, an actuator in one direction may be “slaved” to an actuator or encoder in another direction such that, for example, vertical displacement is accompanied by a forced horizontal component so as to ensure that the foot-supports follow the prescribed path. A similar effect can be achieved by defining sliding limit-switch ranges where the actuators generate high resistance to forces attempting to move outside an envelope defined around the prescribed path of motion. Details of these and other possible implementations will be clear to one ordinarily skilled in the art.

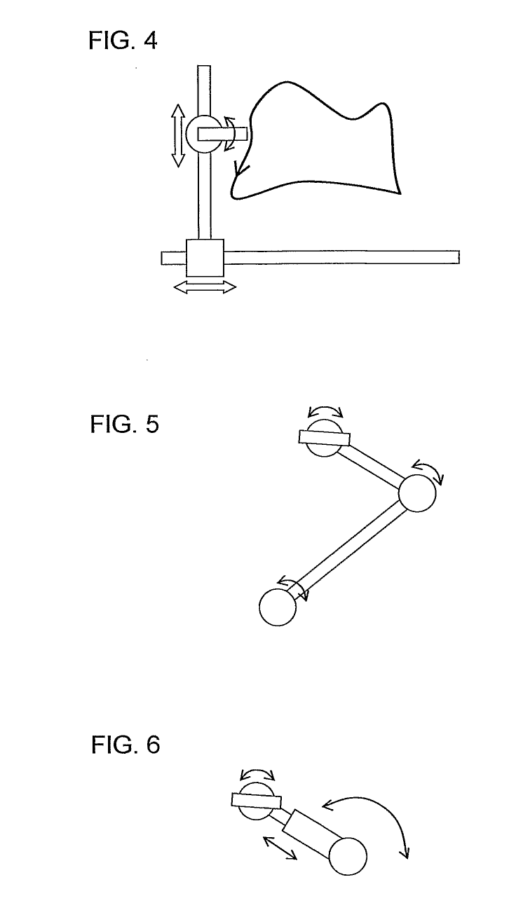

It will be appreciated that the present invention differs significantly from most conventional exercise devices in that it employs an actuator system which is inherently capable of following a substantially arbitrary path defined within the range of motion in two or more dimensions. This capability allows control system 18 to change the arbitrary path during the course of an uninterrupted exercise session. In other words, the exercise device may switch between different paths of motion, for example corresponding to: a cycling motion (FIG. 1); a stepping motion (FIG. 2); a walking motion; a running motion; or a skiing motion (FIG. 3), during the course of an ongoing exercise session. Similarly, it may vary continuously between such paths of motion, or may implement other less-standard paths of motion (FIG. 4). Thus, a structured training session requiring a given amount of time on each of a number of different types of exercise devices can be implemented without interruption using a single exercise device constructed according to the teachings of the present invention.

In addition to providing different types of exercise motions, the present invention preferably allows for adjustment of various parameters of each type of motion. For example, exercises may be instantaneously adapted to the step size of the user by electronic control only, without requiring any mechanical adjustment of the exercise device. Thus, the same exercise device can be used alternately by a professional basketball player and by a child without requiring mechanical adjustment.

Parenthetically, it should be noted that the feet of the user do not necessarily need to remain in continuous contact with the foot-support surfaces during the entire cycle of motion. Thus, for example, in a walking-type motion, the return motion of the users foot may be through the air, again meeting the foot-support surface at the forward end of the motion.

Another optional feature of the present invention is that control system 18 may be associated with an audio-visual entertainment system 20. According to this option, control system 18 is preferably configured to vary the arbitrary path synchronously with events presented by the audio-visual entertainment system. For example, in a video presentation, an initial walking motion may be replaced by a stepping motion as the video illustrates having reached stairs which need to be climbed. Optionally, the path of motion may be modified by motion simulation effects generated synchronously with events presented by the audio-visual entertainment system. According to this option, the stepping motion may be modified by a shaking motion as an earthquake is portrayed by the entertainment system. Additionally, or alternatively, other parameters of operation of the device may be modified, including but not limited to, the resistance against motion, or the speed of the motion. For example, the resistance may be increased as the video content portrays stepping up a hill, or the speed may increase as the video portrays cycling down a hill.

A further option for implementation of the present invention employs connection to a communications network, and allows participation in competitive online gaming. Here too, the device preferably employs some or all of the features described above in the context of operation with an audio-visual entertainment system.

The two foot-support surfaces of the present invention may be displaced in equal but opposite motions. This mode of operation is suited to a range of exercises including conventional motions such as cycling, stepping, elliptical skiing etc.

In another mode of operation, the foot-support surfaces are displaced synchronously in parallel motions. This may correspond to a jumping motion, or may simulate a rowing motion or the like.

According to another mode of operation, the first and second foot-support surfaces may be displaced non-synchronously. This is true to a mild extent in walking simulation where the return path of the foot is not symmetrical with the path of the load-bearing foot. In other simulations, the asymmetry may be more pronounced.

Optionally, the system described thus far may be supplemented with similar actuator elements and hand-support surfaces to provide synchronous hand motions. By way of one non-limiting example, this may be used for providing standard elliptical exerciser functionality.

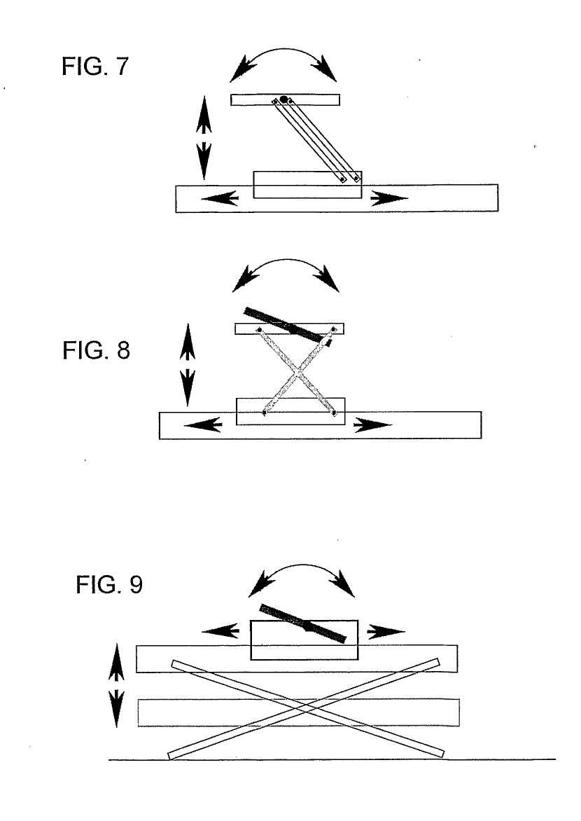

It should be noted that the present invention may be implemented with substantially any type of actuators or combination of types of actuator which can produce the required motion. Examples include, but are not limited to, combinations of linear actuators (FIGS. 1-4), rotary actuators on jointed arms (FIG. 5) and combinations of linear and rotary actuators such as illustrated in FIG. 6. Optionally, an implementation such as that of FIG. 5 may advantageously be implemented using an arrangement of drive belts to control rotation at each joint, as is known in the field of robotics. Additional non-limiting examples shown in FIGS. 7-9 include a parallel-action lever mechanism over a linear actuator, a scissors lift mechanism over a linear actuator, and a linear actuator over a scissors lift mechanism, respectively.

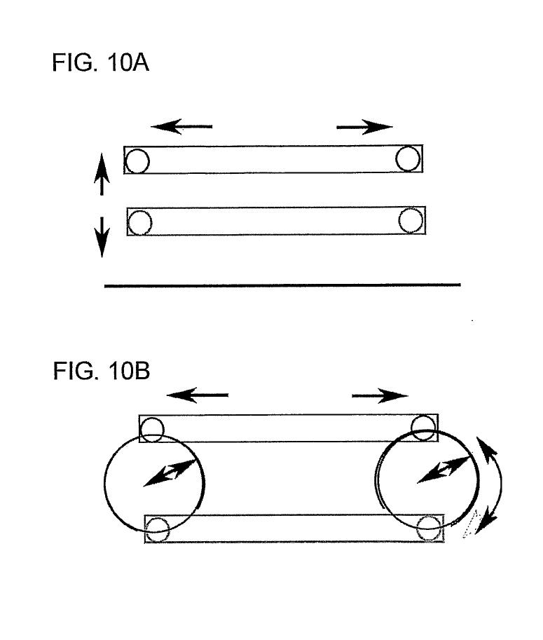

A further option is illustrated schematically in FIGS. 10A and 10B. Here, each foot is provided with a support surface implemented as part of a small conveyor belt, typically deployed roughly horizontally but optionally subject to a fixed or variable tilting or other adjustment. Each conveyor belt is typically provided with a motor arrangement for driving it bi-directionally. Each foot-supporting conveyor is mounted so as to be displaceable vertically, such as along a linear path (FIG. 10A) or via a rotating system of arms with constant or variable radius (FIG. 10B) or through an arcuate motion. The combination of linear translation along the conveyor belt plus the motion of the conveyor itself up and down provides the required freedom to define a path of foot motion in two dimensions. For passive motion modality, i.e., where the user generates the motion, the foot support is deployed so as to allow the user to displace the foot support to generate vertical motion with any desired resistance, and the conveyor mechanism is actuated as a function of the vertical motion so as to generate motion in the roughly perpendicular (roughly horizontal) direction in order to direct the foot along the desired path of motion (and correcting for any horizontal component in the overall vertical motion of the conveyor belt. For active operation, both the vertical motion and the horizontal conveyor motion are power driven. Optionally, the device may be configured such that, if both conveyor mechanisms are positioned side by side at the same height and driven in the same direction, the device also offers conventional treadmill functionality.

In all of the above cases, the actuators themselves may be electrically controlled (e.g., using servo motors, stepper motors, linear motors), hydraulic actuators, or pneumatic actuators or may be driven by drive belts which are themselves driven by any suitable type of actuator, all according to the structural requirements of each implementation.

It will be appreciated that the above descriptions are intended only to serve as examples, and that many other embodiments are possible within the scope of the present invention as defined in the appended claims.

What is claimed is:

1. An exercise device comprising:
(a) a first foot-support surface;
(b) a second foot-support surface;
(c) an actuator system associated with said first and second foot-support surfaces and configured to displace each of said first and second foot-support surfaces along an arbitrary path defined in at least two dimensions over a range of at least 25 centimeters by 15 centimeters; and
(d) a control system associated with said actuator system and configured for controlling said actuator system so as to generate an exercise path for each of said first and second foot-support surfaces.

2. The exercise device of claim 1, wherein said actuator system is configured to displace each of said first and second foot-support surfaces along an arbitrary path defined in at least two dimensions over a range of at least 70 centimeters by 40 centimeters.

3. The exercise device of claim 1, wherein said actuator system is further configured to control a rotational state of said first and second foot-support surfaces about at least one axis.

4. The exercise device of claim 1, wherein said control system is configured to actively displace said first and second foot-support surfaces along said arbitrary path so as to move the legs of a user.

5. The exercise device of claim 1, wherein said control system is configured to delimit permitted motion of said first and second foot-support surfaces to said arbitrary path such that said first and second foot-support surfaces are moved along said arbitrary path by motion of the legs of a user.

6. The exercise device of claim 5, wherein said actuator system is further configured to generate resistive forces under control of said control system so as to provide a given profile of resistance to motion along said arbitrary path.

7. The exercise device of claim 1, wherein said actuator system is configured to displace each of said first and second foot-support surfaces along an arbitrary path defined in three dimensions.

8. The exercise device of claim 1, wherein said control system is configured to change said arbitrary path during the course of an uninterrupted exercise session.

9. The exercise device of claim 8, wherein said control system is associated with an audio-visual entertainment system, and is configured to vary said arbitrary path synchronously with events presented by said audio-visual entertainment system.

10. The exercise device of claim 9, wherein said control system is configured to switch between at least two arbitrary paths chosen to simulate motions selected from the group consisting of: a cycling motion; a stepping motion; a walking motion; a running motion; and a skiing motion.

11. The exercise device of claim 9, wherein said arbitrary path is modified by motion simulation effects generated synchronously with events presented by said audio-visual entertainment system.

12. The exercise device of claim 8, wherein said control system is configured to switch between at least two arbitrary paths chosen to simulate motions selected from the group consisting of: a cycling motion; a stepping motion; a walking motion; a running motion; and a skiing motion.

13. The exercise device of claim 1, wherein said control system is configured to operate said actuator system in at least one mode wherein said first and second foot-support surfaces are displaced in equal but opposite motions.

14. The exercise device of claim 1, wherein said control system is configured to operate said actuator system in at least one mode wherein said first and second foot-support surfaces are displaced synchronously in parallel motions.

15. The exercise device of claim 1, wherein said control system is configured to operate said actuator system in at least one mode wherein said first and second foot-support surfaces are displaced non-synchronously.

16. The exercise device of claim 1, wherein said actuator system includes a plurality of linear actuators.

17. The exercise device of claim 1, wherein said actuator system includes a plurality of electrically controlled actuators.

18. The exercise device of claim 1, wherein said actuator system includes a plurality of hydraulic actuators.

19. The exercise device of claim 1, wherein said first and second foot-support surfaces are each implemented as parts of a conveyor belt, and wherein said actuator system includes a drive mechanism for driving each of said conveyor belts.
